(19) United States
(12) Patent Application Publication
(10) Pub. No.: US 2024/0044181 A1
(43) Pub. Date: Feb. 8, 2024

(54) Vehicle Lock

(71) Applicant: Bayerische Motoren Werke Aktiengesellschaft, Muenchen (DE)

(72) Inventor: Gero HORNBERGER, Muenchen (DE)

(21) Appl. No.: 18/268,762

(22) PCT Filed: Jan. 10, 2022
(86) PCT No.: PCT/EP2022/050341

§ 371 Date: Jun. 21, 2023

(30) Foreign Application Priority Data
Jan. 11, 2021 (DE) 10 2021 100 298.2

(51) Int. Cl. E05B 79/04; E05B 77/36; E05B 83/18

(52) U.S. Cl. CPC E05B 79/04; E05B 77/36; E05B 83/18

(57) ABSTRACT

A vehicle lock, in particular for a rear hatch, has a lock support with at least two securing points lying opposite each other for securing the lock support to the body of a vehicle, in particular for screwing the lock support thereto. The two securing points lie on an imaginary securing axis. At least one torque support element of the vehicle lock is designed to rest against the body and is positioned so as to support the torque of a rotation about the securing axis.

### BACKGROUND AND SUMMARY

The present invention relates to a vehicle lock. The vehicle lock is used in particular on a rear hatch. Furthermore, the invention relates to a vehicle with the vehicle lock.

Existing vehicle locks are conventionally screwed to the body at at least two attachment points. The vehicle locks serve to lock the closed rear hatch or the closed doors in the closed state.

It is the object of the present invention to provide a vehicle lock, in particular for the rear hatch, which, along with a simple structure and simple installation, makes it possible to utilize the vehicle as safely and conveniently as possible.

The object is achieved by the features of the independent claims. The dependent claims relate to preferred configurations of the invention.

Within the scope of the invention, it has been determined that a vehicle lock, in particular on the rear hatch, can contribute significantly to disruptive noise when a vehicle is being used. In particular, if the vehicle lock is not fixed in a sufficiently rigid manner, a thrumming noise can be produced by the oscillating rear hatch. This “thrumming” is, in particular, a disruptive low-frequency noise caused by the roadway when the vehicle is being driven. It has been determined that, when appropriately excited, the vehicle lock oscillates in particular about the transverse axis of the vehicle, and therefore the rear hatch is not connected in a sufficiently rigid manner to the remainder of the vehicle.

The invention discloses a vehicle lock for use on a vehicle. In particular, the vehicle lock is used on the rear hatch. The vehicle lock is to be connected to the body. This is to be understood to mean that the vehicle lock either is installed on the rear hatch, and therefore moves with the rear hatch when the rear hatch is opened, or is connected on the opposing side to the remaining components of the vehicle.

The vehicle lock has a lock carrier. This lock carrier has at least two opposing attachment points. In particular, two opposing tabs are configured on the lock carrier. At least one attachment point is provided in each tab. The lock carrier particularly preferably comprises exactly two attachment points which lie opposite one another in such a way that the remaining components of the lock, in particular the lock mechanism and the lock housing, are arranged between the two attachment points.

The attachment points are, in particular, through-holes which are used to screw the vehicle lock to the body. A “notional attachment axis” defined for describing the invention extends through the center of the two opposing attachment points. In conventional vehicle locks which have only these two opposing attachment points, oscillation can occur about the notional attachment axis.

In particular when the vehicle lock is used on the rear hatch, the attachment axis extends parallel to the transverse axis Y of the vehicle. Perpendicularly to this transverse axis Y of the vehicle, a vertical axis Z and a longitudinal axis X of the vehicle are defined. Appropriate attachment means, in particular screws, which are used at the attachment points, extend in particular in a plane defined by the longitudinal axis and the vertical axis.

In order to avoid oscillation about the attachment axis, it is provided that the vehicle lock comprises at least one torque support element. This torque support element is an element which protrudes from the vehicle lock and preferably extends at least with a vector perpendicular to the attachment axis. The torque support element is positioned and configured so as to rest on the body. In particular, it is provided that the torque support element is not separately connected to the body, but merely rests on the body. In an optional configuration, a connection, for example a material connection, can also be provided between the body and the torque support element.

In this case, “body” is to be understood to mean everything that cannot be assigned to the vehicle lock, for example a body member made of plastics material or sheet metal or, for example, a rubber element, which in turn rests on the body.

The at least one torque support element is preferably located outside the attachment axis and, depending on the design options, is located as far as possible from the attachment axis. This ensures torque support.

If more than two opposing attachment points are provided for screwing on the vehicle lock, there can be a plurality of attachment axes between the opposing attachment points. In this case, it is preferably provided that at least one torque support element is provided adjacent to or outside each attachment axis in order to support any rotational movement about the attachment axes.

It is preferably provided that at least one torque support element is arranged on either side of the attachment axis. This ensures that the torque is supported in both directions of rotation about the attachment axis.

In general, the vehicle lock and the lock counter-element, which is held in an interlocking manner by the latch of the lock mechanism, are connected in the center between the two attachment points.

Accordingly, it is preferably provided that the torque support elements are arranged as close as possible to the center and therefore as far as possible from the attachment points. The two opposing attachment points are located at a first distance, parallel to the attachment axis, from one another. The at least one torque support element is located at a second distance, parallel to the connection axis, from the closest attachment point. The second distance is preferably at least 10%, more preferably at least 15%, particularly preferably at least 20%, of the first distance.

Furthermore, it is preferably provided that the torque support elements are arranged as far off-center as possible relative to a direction perpendicular to the connection axis. For this purpose, the following is defined: the lock carrier has a width, in particular perpendicular to the attachment axis. The at least one torque support element is arranged at a third distance from the connection axis. This third distance is measured in particular perpendicularly to the connection axis. The third distance is preferably at least 5%, more preferably at least 10%, particularly preferably at least 15%, of the width of the lock carrier.

The width of the lock carrier is, in particular, the largest dimension of the lock carrier in the vehicle plane defined by the longitudinal axis and the vertical axis.

As already described, the vehicle lock preferably comprises a lock housing and a lock mechanism in addition to the lock carrier. The lock mechanism is located substantially between the lock housing and the lock carrier. The lock mechanism is connected in particular to the lock housing and/or the lock carrier.

In particular, the lock mechanism has a latch in a slot. The corresponding counter-element is inserted into this slot, in particular when the rear hatch is being closed, and held in an interlocking manner by the latch.

The at least one torque support element is preferably located on the lock housing. For this purpose, the torque support element either is attached directly to the lock housing or is an integral component of the lock housing.

The invention further comprises a vehicle with the vehicle lock described. The vehicle lock is provided in particular for locking the rear hatch.

The vehicle lock is attached, in particular screwed, to the body via the at least two attachment points. In this arrangement, the torque support element(s) rests/rest on the body.

It is in particular provided, as already described with regard to the vehicle lock, that at least one torque support element is located on either side of the attachment axis respectively. When installed on the vehicle, the torque support elements preferably rest simultaneously on the body on both sides of the attachment axis in such a way that both directions of rotation are directly supported.

The attachment axis preferably extends parallel to the transverse axis of the vehicle.

Further details, features and advantages of the invention are set out in the following description and the figures.

### BRIEF DESCRIPTION OF THE DRAWINGS

FIG. 1 shows a vehicle with an exemplary embodiment of a vehicle lock according to the invention;

FIG. 2 is a detail view of the exemplary embodiment of the vehicle lock according to the invention on the body; and

FIG. 3 is a further view of the exemplary embodiment of the vehicle lock according to the invention.

### DETAILED DESCRIPTION OF THE DRAWINGS

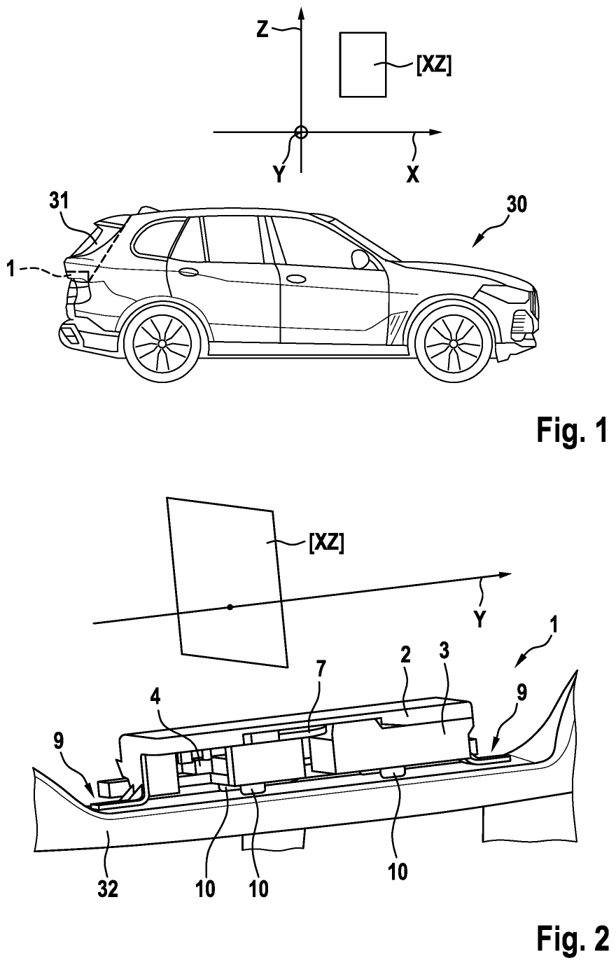

A vehicle lock 1 of a vehicle 30 is described in detail below with reference to FIGS. 1 to 3.

FIG. 1 shows the vehicle 30 configured as a double-track road vehicle. A longitudinal axis X, a transverse axis Y and a vertical axis Z, which are each perpendicular to one another, are defined on the vehicle 30. The longitudinal axis X and the vertical axis Z define the depicted plane [XZ].

The vehicle 30 has a rear hatch 31. The rear hatch 31 can be locked with the vehicle lock 1.

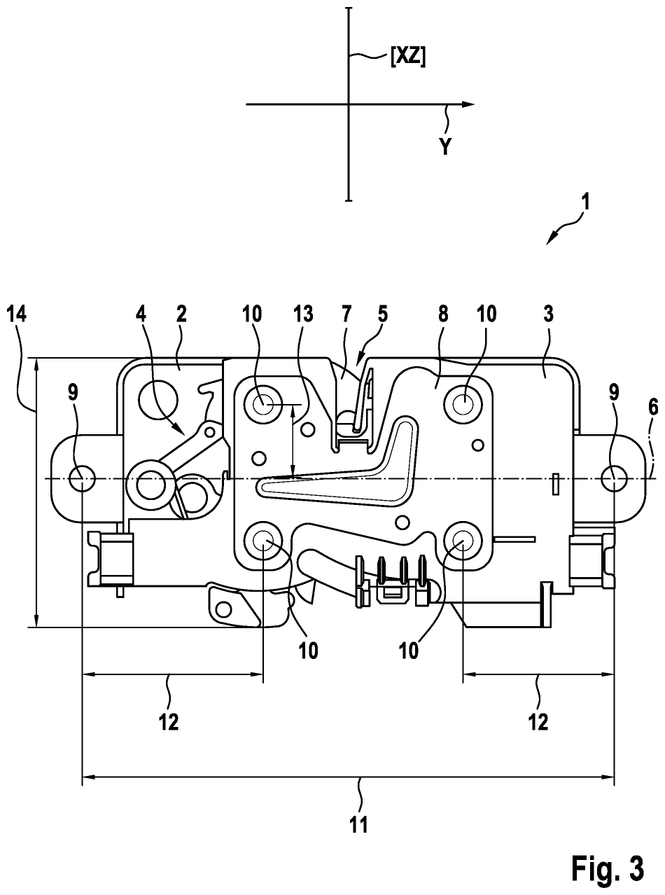

FIGS. 2 and 3 show the vehicle lock 1 in detail. FIG. 2 shows a portion of a body 32 of the vehicle 30 to which the vehicle lock 1 is attached.

The vehicle lock 1 has a lock carrier 2. The lock carrier 2 comprises two opposing attachment points 9, configured in this case as through-holes. Screws which extend in the [XZ] plane are fitted through these attachment points 9 so as to connect the lock carrier 2 to the body 32.

In addition to the lock carrier 2, the vehicle lock 1 comprises a lock housing 3 and a lock mechanism 4. The lock mechanism 4 is located substantially between the lock housing 3 and the lock carrier 2.

A slot 5 is provided in the lock housing 3. The counter-element projects into this slot 5 and is locked by a latch 7 of the lock mechanism 4.

Located on the underside of the lock housing 3 is a plate 8 with four torque support elements 10, which all rest on the body 32 simultaneously when the vehicle lock 1 has been installed.

FIG. 3 in particular illustrates a notional attachment axis 6 which extends through the center of the two opposing attachment points 9. In the exemplary embodiment shown, it therefore extends parallel to the transverse axis Y.

Parallel to the attachment axis 6, the two attachment points 9 are spaced apart from one another by a first distance 11. The torque support elements 10 are located at a second distance 12 from the closest attachment point 9. The ratio between these two distances 11, 12 has been described in the general part of the description.

The lock carrier 2 has a width 14 in the [XZ] plane. The respective torque support element 10 is spaced apart from the attachment axis 6 by a third distance 13. The ratio between the third distance 13 and the width 14 is also described in the general part of the description.

### LIST OF REFERENCE SIGNS

1 vehicle lock
2 lock carrier
3 lock housing
4 lock mechanism
5 slot
6 attachment axis
7 latch
8 plate
9 attachment points
10 torque support elements
11 first distance
12 second distance
13 third distance
14 width
30 vehicle
31 rear hatch
32 body
X longitudinal axis
Y transverse axis
Z vertical axis

1.-10. (canceled)

11. A vehicle lock, comprising:
a lock carrier with at least two opposing attachment points for attaching the lock carrier to a body of a vehicle, wherein the two attachment points lie on a notional attachment axis; and
at least one torque support element configured for resting on the body and being positioned to support a rotation torque about the attachment axis.

12. The vehicle lock according to claim 11, wherein
screws attach the lock carrier to the body.

13. The vehicle lock according to claim 11, wherein
at least two torque support elements are provided, one being arranged on each side of the attachment axis.

14. The vehicle lock according to claim 11, wherein
the at least two opposing attachment points are located at a first distance, parallel to the attachment axis, from one another, and
the at least one torque support element is located at a second distance, parallel to the attachment axis, from the closest attachment point, and
the second distance is at least 10% of the first distance.

15. The vehicle lock according to claim 14, wherein
the second distance is at least 15% of the first distance.

16. The vehicle lock according to claim 14, wherein
the second distance is at least 20% of the first distance.

17. The vehicle lock according to claim 11, wherein
the lock carrier, perpendicular to the attachment axis, has a width and
the at least one torque support element is located at a third distance from the attachment axis,
the third distance is at least 5% of the width.

18. The vehicle lock according to claim 17, wherein
the third distance is at least 10% of the width.

19. The vehicle lock according to claim 17, wherein
the third distance is at least 15% of the width.

20. The vehicle lock according to claim 11, further comprising:
a lock housing, and
a lock mechanism, wherein
the lock housing is attached to the lock carrier,
the lock mechanism is attached to the lock carrier and/or the lock housing, and
the at least one torque support element is attached to the lock housing or is an integral component of the lock housing.

21. The vehicle lock according to claim 20, wherein
the lock housing has a slot for inserting a counter-element and the lock mechanism is configured for locking the counter-element.

22. A vehicle, comprising:
a rear hatch; and
a vehicle lock for the rear hatch, the vehicle lock comprising:
a lock carrier with at least two opposing attachment points for attaching the lock carrier to a body of a vehicle, wherein the two attachment points lie on a notional attachment axis; and
at least one torque support element configured for resting on the body and being positioned to support a rotation torque about the attachment axis.

23. The vehicle according to claim 22, wherein
the vehicle lock is attached to the body via the at least two attachment points, and wherein the at least one torque support element rests on the body.

24. The vehicle according to claim 23, wherein
at least two torque support elements are provided, one being arranged on each side of the attachment axis and resting at a same time on a body of the vehicle.

25. The vehicle according to claim 22, wherein
the attachment axis extends parallel to a transverse axis of the vehicle.
